(19) United States
(12) Patent Application Publication
(10) Pub. No.: US 2005/0166226 A1
(43) Pub. Date: Jul. 28, 2005

(54) Parental control channel list tracking

(75) Inventor: Khelan Maheshchandra Modi, Indianapolis, IN (US)

Correspondence Address: THOMSON LICENSING INC., PATENT OPERATIONS, PO BOX 5312, PRINCETON, NJ, 08543-5312, US

(73) Assignee: Thomson Licensing S.A., F-92100 Boulogne-Billancourt (FR)

(21) Appl. No.: 10/512,362

(22) PCT Filed: Apr. 10, 2003
(86) PCT No.: PCT/US03/11203

Related U.S. Application Data
(60) Provisional application No. 60/374,887, filed on Apr. 23, 2002.

(51) Int. Cl. G06F 13/00

(52) U.S. Cl. 725/38

(57) ABSTRACT

In a digital television signal processor, digital television channel viewing status (e.g., blocked or viewable) is stored according to the physical channel number of a digital television channel rather than its virtual channel number. In this manner, the selected state (e.g., blocked or viewable) of a digital channel's viewing status is implemented regardless of whether an off-air guide containing virtual channel number data is enabled or disabled. Since the virtual channel number of a digital television channel may not be the same as the physical channel number, storing the selected state of a digital channel according to its physical channel number assures that the selected viewing state is followed.

This U.S. non-provisional patent application claims the benefit of and/or priority to U.S. provisional patent application Ser. No. 60/374,887 filed Apr. 23, 2002 entitled “Parental Control Channel List Tracking Through Off-Air Guide State (On/Off) Changes” both of which are commonly assigned.

### BACKGROUND

1. Field of the Invention

The present invention concerns digital television and, more particularly, a system for processing television signals that keeps track of digital channels (e.g. ATSC) in a Parental Control Channel List correctly irrespective of whether a feature known as the “off-air guide” is available or not.

2. Background Information

Digital television signals or channels, in accordance with the Advanced Television Systems Committee (e.g. ATSC), contain Program and System Information Protocol (PSIP) information or data. Briefly, PSIP is a small collection of tables designed to operate within every Transport Stream (TS) for terrestrial broadcast of digital television. Its purpose is to describe the information at the system and event levels for all virtual channels carried in a particular transport stream. Additionally, information for analog channels as well as digital channels from other transport streams may be incorporated.

There are two main categories of information in the ATSC PSIP standard, system information and program data. System information allows navigation and access of the channels within the DTV transport stream. The program data provides necessary information for efficient browsing and event selection. Some tables announce future events and some are used to locate the digital streams that make up an event. The PSIP data are carried via a collection of hierarchically arranged tables. The PSIP information includes what is known as an off-air guide in addition to other information. The off-air guide includes virtual channel number, program title and other information that are used to display various information regarding a given program and channel.

In accordance with Federal Communications Commission (FCC) mandate, digital televisions are required to implement what is known as the V-chip standard. The V-chip standard provides a user (e.g. parental) control over the viewing of a particular television program or of an entire television channel. Essentially, the V-chip standard provides for the audio and video blocking of a particular television program or television channel. In accordance with this mandate, televisions now allow the user to selectively block the viewing of a particular television channel. The viewing state (i.e. blocked and/or viewable) of a particular television is retained in memory within the television. With respect to digital television channels, the viewing state of a particular television channel is currently maintained according to its virtual channel.

Certain televisions, however, may include an option for a user to disable the off-air guide. Since the virtual channel number may not be the same as the physical channel number, a desired television channel will not be blocked when the off-air guide is disabled and its physical channel is not the same as its virtual channel.

It is evident from the above that there is a need for implementing parental control in a television signal processing system that is able to block a desired television channel whether or not virtual channel data for the television channel is received by the television signal processing system.

It is further evident from the above that there is a need for tracking a parental control channel list irrespective of whether or not virtual channel data for the television channel is received by the television signal processing system.

It is moreover evident from the above that there is a need for correlating parental control status information regarding a television channel

### SUMMARY OF THE INVENTION

In a digital television signal processing system, a digital television channel viewing status is stored according to the physical channel number of a digital television channel rather than its virtual channel number. In this manner, the selected state of a digital channel's viewing status is implemented regardless of whether an off-air guide containing virtual channel number data is enabled or disabled. Since the virtual channel number of a digital channel may not be the same as the physical channel number, storing the selected state of a digital channel according to its physical channel number assures that the selected viewing state is followed.

In one form, there is provided a method of storing viewing status of a digital television channel in a digital television signal processing system comprising (a) receiving user selection of a viewing state of a particular digital television channel; and (b) storing the selected viewing state of the particular digital television channel according to its physical television channel number.

### BRIEF DESCRIPTION OF THE DRAWINGS

In the drawings:

FIG. 1 is a block diagram representation of a digital television system incorporating a television signal processing system in accordance with the principles of the subject invention;

FIG. 2 is a block diagram of an exemplary television signal processing system in accordance with the principles of the subject invention;

FIG. 3 is a representation of an on-screen display of an exemplary channel viewing status list; and

FIG. 4 is a flowchart of an exemplary manner of operation of the subject invention.

Corresponding reference characters indicate corresponding parts throughout the several views.

### DESCRIPTION OF THE PREFERRED EMBODIMENTS

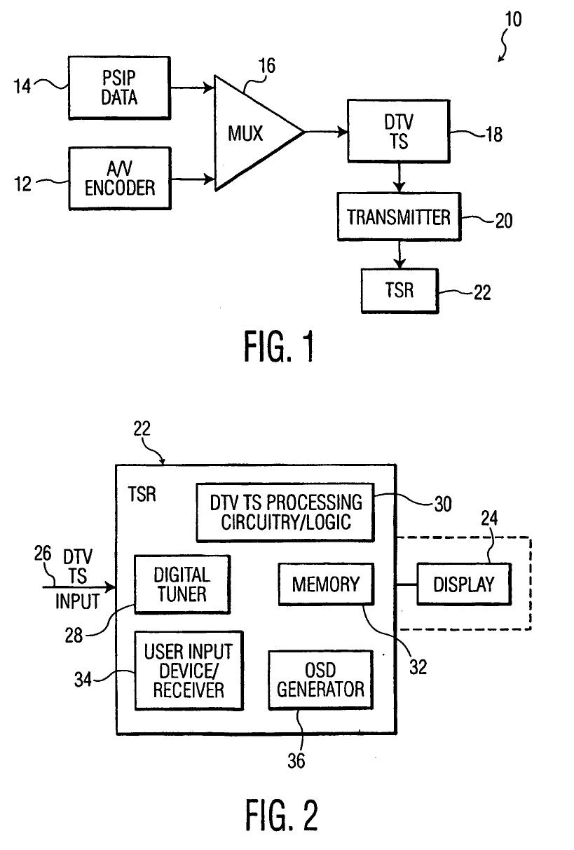

Referring now to FIG. 1, there is depicted a block diagram of a digital television system 10. A digital television signal processing system as described herein is intended to encompass various types of systems and devices including, but not limited to, digital television signal processing devices and systems that include a display device and digital television signal processing devices and systems that do not include a display device (e.g., set top box such as a satellite television signal receiver). Various terms such as “television receiver”, “television signal receiver”, “television system”, “television signal processor”, “television device”, “television apparatus”, etc., as used herein are intended to encompass all types of television signal processing systems, including those systems that include a display device and those that do not.

In FIG. 1, the digital television system 10 includes an audio/video encoder 12 that is operative, configured and/or adapted to receive audio and video signals and digitally encode the audio and video (A/V) signals in accordance with a particular digital encoding technique or scheme. The digital television system 10 also includes a PSIP data compiler 14. The PSIP data compiler 14 is operative, configured and/or adapted to receive PSIP data, including and encompassing off-air guide data, and digitally encode the PSIP data.

A multiplexer (MUX) 16 is also provided in the system 10. The multiplexer 16 has two inputs and a single output. One input of the multiplexer 16 receives the digitally encoded (digital) PSIP data/signal, while the other input of the multiplexer 16 receives the digitally encoded (digital) A/V data/signal. The multiplexer 16 provides a multiplexed digital data/signal at its output consisting of the PSIP data/signal and the A/V data/signal.

The output of the multiplexer 16 is provided to a digital television (DTV) transport stream (TS) creator/compiler 18 that is adapted, configured and/or operative to assemble the digital PSIP and A/V data/signal into a digital transport stream in accordance with ATSC digital television standards. The digital television transport stream creator/compiler 18 is connected to a transmitter 20. The transmitter 20 is adapted, configured and/or operative to transmit the digital television transport stream as a digital television signal. The transmission of the digital television signal is accomplished to a known digital transmission standard, technique or scheme. It should be appreciated that the transmitter 20 is representative of an original transmission as via an over-the-air transmitter, a satellite transmission or the like, as well as a re-transmission such as via a cable television system. In any case, the system 10 includes a television signal receiver (TSR) 22 that is adapted, configured and/or operative to receive the digital television signal and process the digital television system. The television signal receiver 22 is also adapted, configured and/or operative to function in the manner set forth herein, and particularly in accordance with the present principles.

Referring now to FIG. 2, there is depicted a block diagram of an exemplary television signal receiver 22 in accordance with the principles of the subject invention. The television signal receiver 22 may or may not include an integral display 24 as represented by the dashed lines. In the case that the television signal receiver 22 does not include an integral display, e.g., a set-top box, the television signal receiver 22 is connectable to a display 24. In both cases the display 24 is adapted, configured and/or operative to provide on-screen display of information such as set-up menus, status lists such as a channel viewing status list or the like, preference selection and/or status lists, and/or the like, some of which are described herein in connection with the principles of the present invention and some of which are known in the art. The television signal receiver 22 may therefore be embodied as a television (having an integral display), a set-top box (connectable to a display), or the like.

The television signal receiver 22 has an input 26 that is adapted, configured and/or operative to be connected to and thus receive a plurality of digital television (DTV) transport streams (TS) or signals. The digital television signal is provided on a particular television channel (frequency) and contains one or more digital transport streams. The particular television channel is the physical channel of the digital television signal, while the transport stream defines one or more virtual channels. The physical channel may be the same or different than the virtual channel. A digital tuner 28 is provided that is adapted, configured and/or operative to receive and tune a particular physical channel.

The television signal receiver 22 further includes a digital television signal processor (DTV) which may comprise signal processing circuitry and/or logic hardware, signal processor software routines executed, e.g., via a processor such as a microprocessor or digital signal processor, signal processing means, or the like 30. While the digital television processor is depicted as a single block, it should be appreciated that the digital television processor 30 may be embodied, e.g., as a microprocessor executing signal processor software routines and/or as one or more integrated circuits (ICs) with or without additional circuitry/logic. The digital television processor 30 is adapted, configured and/or operative to process the digital television signal/transport stream(s) in order to obtain the audio information for sound reproduction, the video information for display, and obtain the PSIP information including the off-air guide. The digital television processor 30 is further adapted, configured and/or operative to perform other television signal receiver tasks such as are typical and/or known in the art and to generally control, regulate and/or operate the components of the television signal receiver 22. To this end, the digital television processor 30 is adapted, configured and/or operative to utilize programming (software) or program instructions that are stored in a memory 32.

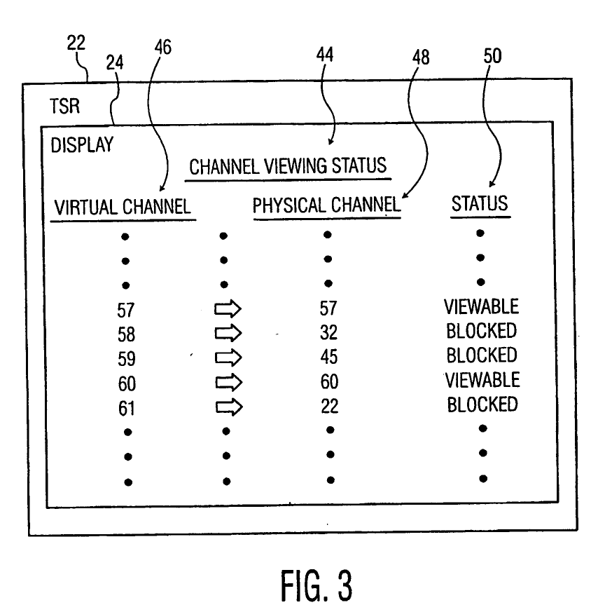

Moreover, the television signal receiver 22 includes an on-screen display (OSD) generator 36 that is adapted, configured and/or operative to generate, under control of the processor 30 and/or program instructions stored in the memory 32, on-screen display signals the allow the display 24 to depict or show various text messages, menus, lists and/or the like with or without various graphics. In one exemplary instance, and as depicted in FIG. 3 and discussed further below, the on-screen display generator 36 provides on-screen display of a channel viewing status menu 44, virtual channels available for viewing (from the off-air guide), physical channels available for viewing and correlated to the virtual channel, and user-selected preferences associated therewith.

Still further, the television signal receiver 22 includes a user input device and/or receiver 34. The user input device/receiver 34 is adapted, configured and/or operable to accept or receive input from a user regarding an aspect, feature and/or preference with regard to the television signal receiver 22. In one form, the user input device/receiver 34 may be a remote control (not shown) and associated remote control receiver such as an IR transmitter/receiver. In another form, the user input device/receiver 34 may be a panel of buttons or the like that allow user input. User input is accepted by the television signal receiver 22 for various purposes such as in response to function and/or feature choices provided as on-screen menu choices and/or options.

It should be appreciated that the television signal receiver 22 also includes other components not particularly shown and/or described herein that are typical of digital television signal receivers. Moreover, the television signal receiver 22 is capable of many features and/or functions typical of current television signal receivers.

The television signal receiver 22 stores program instructions in the memory 32 which are executable by the processor 30 that provide for the viewing and/or blocking of a particular television channel or channels. This is known as V-chip, parental control, channel viewing status or state, or otherwise. While the television signal receiver 22 includes the ability to lock or otherwise control access (set-up and/or changing the settings thereof) to this feature, function and/or ability, such is beyond the scope of this disclosure and will not be described in detail other than it functions in a manner typical of such a feature. The television signal receiver also may provide for the temporary viewing of a blocked channel based on an inputted code, personal identification number (PIN), or the like. This is accomplished in a manner known in the art.

With reference to FIG. 3, an on-screen display of an exemplary channel viewing status list or menu 44 is shown. The channel viewing status menu 44 is provided to the display 24 via the on-screen display generator 36. The channel viewing status menu 44 allows for the setting and/or changing of the viewing status or state of a particular television channel by the user, typically a parent. Additionally, the channel viewing status menu 44 shows the current viewing status (i.e. blocked or viewable) 50 of a particular channel and/or all of the available television channels. In the example shown, all of the available channels (from a particular digital channel source or all digital channel sources) are provided in a scrolling menu fashion.

The channel viewing status/state menu/list 44 displays the virtual channel number 46 of an available channel, the physical channel number 48 corresponding to the virtual channel number 46, and the viewing status or state 50 thereof. Via user input, a user is allowed to set the viewing status of any particular television channel to either viewable or blocked. The user is also allowed to change/toggle the viewing status from one state to another. When a channel (channel status or state) is set to viewable, the channel will be shown and heard during a channel search. When the channel (channel status or state) is set to blocked, the channel will either not be shown or heard (i.e. blank) during a channel search (i.e. a channel up/down or number input command), or will not show up (i.e. be skipped) during a channel search (i.e. a channel up/down or number input command).

In FIG. 3, it is seen that virtual channel 57 corresponds to physical channel 57 (the same channel number) and that the viewing status or state of this digital television channel is set to viewable. Virtual channel 58 corresponds to physical channel 32 (a different channel number) and that the viewing status or state of this digital television channel is set to blocked. Virtual channel 59 corresponds to physical channel 45 (again, a different channel number) and that the viewing status or state of this digital television channel is set to blocked. Other examples are self-evident.

While it is not necessary for both the virtual channel number and the physical channel number to be shown on the channel viewing status menu 44, it is depicted in FIG. 3 for clarity. Either the virtual channel number of the physical channel number may be shown on the channel viewing status menu 44. This may depend on whether the off-air guide is enable or disabled. Of course, it should be appreciated that the manner of displaying and/or inputting viewing status information is only exemplary and other manners of inputting channel viewing status preferences, selections or choices are contemplated, as well as manners of presenting the information to a user.

Regardless of whether the television signal receiver 22 allows the user to select a particular television channel for viewing or blocked based on its physical or virtual channel number, the television signal receiver 22 stores the channel viewing status (i.e. viewable or blocked) based on the physical channel number 48 rather than on the virtual channel number 46. Referring to FIG. 3, when the off-air guide is off (disabled), physical channel 45 is displayed and located at channel position 45. When the off-air guide is on (enabled), virtual channel 59 is displayed and located at channel position 59, since the television signal receiver 22 utilizes the off-air guide information to display the channel number and other PSIP information. The physical channel number 48 does not change, but the virtual channel number 46 may change. The television signal receiver 22 provides for the correlation of the physical channel to its virtual channel to provide viewing or blocking irrespective of whether the off-air guide is on or off.

Thus, for example, assume that the off-air guide is enabled so that virtual channel 59 shows up as 59 (or 59-1) on the television signal receiver 22. If a user selects to block channel 59 in the channel list and then turns the off-air guide off (disables the off-air guide), performs a channel search, then goes back to the channel viewing status 44, one would see that channel 45 is blocked. The menu 44 cannot display the virtual channel numbers if the off-air guide is disabled, only when the off-air guide is enabled. There would not be a channel 59 as it is a virtual channel and once the off-air guide is disabled and a channel search is performed, channel 59 no longer exists. Similarly, if the off-air guide is off (disabled), channel 45 is blocked, and then the off-air guide is enabled followed by a channel search, the channel list 44 would show channel 59 as blocked. Channels 45 and 59 are the same digital channels, so that channel block and viewing will operate no matter whether the off-air guide is enabled or disabled.

It should be appreciated that the channel viewing status or state may be stored with respect to the physical channel according to either a default condition or as viewable or blocked. Stated another way, the status or state (i.e. viewable or blocked) of a digital television channel may be stored as blocked or viewable depending on user selection with respect to the physical channel, or the status or state may stored as blocked with the default condition being viewable, or as viewable with the default condition being blocked. Other manners of storing and/or correlating the channels may be used.

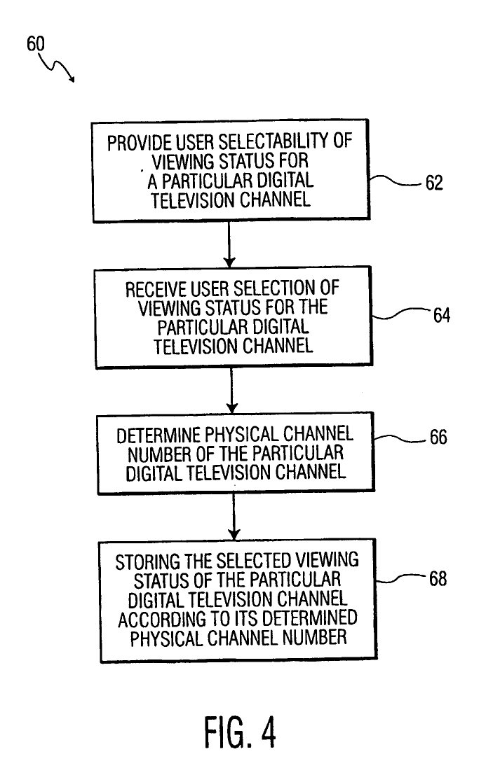

Referring now to FIG. 4, there is depicted a flowchart, generally designated 60, of an exemplary manner of operation of the television signal receiver 22 in accordance with the principles of the subject invention. In block 62, the television signal receiver 22 provides user selectability of viewing status for a particular digital television channel. This may be accomplished as provided by the on-screen channel viewing status menu 44 of FIG. 3. In block 64, the television signal receiver 22 receives user selection of a viewing status for the particular digital television channel as provioded for by the on-screen menu. Particularly, the television signal receiver 22 allows the user to select the status or state (i.e. blocked or viewable) of a particular digital television channel via the on-screen menu and the user input device/receiver.

In block 66, the television signal receiver 22 then determines the physical channel number of the particular digital television channel. Thereafter, in block 68, the television signal receiver 22 stores the selected viewing status, in a manner provided herein, of the particular digital television channel according to its determined physical channel number. This allows the television signal receiver to implement the selected viewing status for a digital television channel regardless of whether the off-air guide is enabled or disabled.

It should be appreciated that a method in accordance with the principles of the subject invention may contain more steps than described in conjunction with the flowchart 60 of FIG. 4 and/or different or modified steps than that described. As well, other manners of correlating a viewing status or state, regardless of the enabling or disabling of an off-air guide, to the physical channel number of the particular digital television channel and not its virtual channel number are contemplated and expected.

While this invention has been described as having a preferred design, the present invention can be further modified within the spirit and scope of this disclosure. This application is therefore intended to cover any variations, uses, of adaptations of the invention using its general principles. Further, this application is intended to cover such departures from the present disclosure as come within known or customary practice in the art to which this invention pertains and which fall within the limits of the appended claims.

1. A method of storing viewing status of a digital television channel comprising:
receiving user selection of a viewing state of a particular digital television channel; and
storing the selected viewing state of the particular digital television channel according to its physical television channel number.

2. The method of claim 1, wherein receiving user selection of a viewing state of a particular digital television channel includes:
providing an on-screen viewing status menu having user-selectable viewing states for a particular digital television channel.

3. The method of claim 2, wherein providing an on-screen viewing status menu having user-selectable viewing states for a particular digital television channel includes:
providing an on-screen display of all available digital television channels having user selectable viewing states for each available digital television channel.

4. The method of claim 1, further comprising:
determining a physical channel number of the particular digital television channel before storing the selected viewing state of the particular digital television channel.

5. The method of claim 1, further comprising:
correlating the physical channel number of the particular digital television channel to its virtual channel number.

6. Television signal processing apparatus comprising:
a signal processor;
an on-screen display generator in communication with said signal processor;
a user-input receiver in communication with said signal processor; and
memory in communication with said signal processor and storing program instructions which, when executed by said signal processor, causes the television signal receiver:
receive user selection of a viewing state of a particular digital television channel; and
store the selected viewing state of the particular digital television channel according to its physical television channel number.

7. The television signal processing apparatus of claim 6, wherein said memory has further program instructions which, when executed by said signal processor, causes the television signal receiver to:
provide an on-screen viewing status menu having user-selectable viewing states for a particular digital television channel.

8. The television signal processing apparatus of claim 7, wherein said memory has further program instructions which, when executed by said signal processor, causes the television signal receiver to:
provide an on-screen display of all available digital television channels having user selectable viewing states for each available digital television channel.

9. The television signal processing apparatus of claim 6, wherein said memory has further program instructions which, when executed by said signal processor, causes the television signal receiver to:
determine a physical channel number of the particular digital television channel before storing the selected viewing state of the particular digital television channel.

10. The television signal processing apparatus of claim 6, wherein said memory has further program instructions which, when executed by said signal processor, causes the television signal receiver to:
correlate the physical channel number of the particular digital television channel to its virtual channel number.

11. A television signal processing apparatus (comprising:
a digital television signal processor;
a user-input receiver in communication with said digital television signal processor; and
memory in communication with said digital television signal processor and storing program instructions executable by said digital television signal processing circuitry;
wherein said user-input receiver is operative to receive user selection of a viewing state of a particular digital television channel; and
said memory is operative to store the selected viewing state of the particular digital television channel according to its physical television channel number.

12. The television signal processing apparatus of claim 11, further comprising:
an on-screen display generator in communication with said digital television signal processor and operative to provide an on-screen viewing status menu having user-selectable viewing states for a particular digital television channel.

13. The television signal processing apparatus of claim 12, wherein said on-screen display generator is further operative to provide an on-screen display of all available digital television channels having user selectable viewing states for each available digital television channel.

14. The television signal processing apparatus of claim 11, wherein said digital television signal processor is further operative to:
determine a physical channel number of the particular digital television channel before storing the selected viewing state of the particular digital television channel.

15. The television signal processing apparatus of claim 11, wherein said digital television signal processor is further operative to:
correlate the physical channel number of the particular digital television channel to its virtual channel number.
